(19) United States
(12) Patent Application Publication
(10) Pub. No.: US 2003/0043857 A1
(43) Pub. Date: Mar. 6, 2003

(54) Multiplexing transmission system and its data transfer method

(75) Inventors: Kazuo Takagi, Tokyo (JP); Masaki Umayabashi, Tokyo (JP); Makoto Shibutani, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/232,325

(22) Filed: Sep. 3, 2002

(30) Foreign Application Priority Data
Sep. 4, 2001 (JP) 2001-267645

(51) Int. Cl. H04J 3/06; H04J 3/02

(52) U.S. Cl. 370/503; 370/537

(57) ABSTRACT

A remote station creates a transfer frame with one synchronous bit string added to at least one or more client frames and sends this transfer frame to a base station, when multiplexing the client frame received from a client system through an optical fiber and transferring the same to the base station.

### BACKGROUNDS OF THE INVENTION

1. Field of the invention

The present invention relates to a multiplexing transfer system in which, with a plurality of remote stations connected to one base station through a transmission medium (optical fiber and the like), client frames such as ATM (Asynchronous Transfer Mode) cells and Internet Protocol (IP) packets sent from the respective remote stations are multiplexed through the transmission medium and transferred to the base station, and its data transfer method.

2. Description of the Related Art

Recently, a multimedia communication service of sounds, images, or Internet is prevalent, and according to this, it is required that a communication path of large capacity should be realized. This requirement for increasing the capacity of a communication path is often found not only in a main communication path but also in a subscriber communication path for access, and the optical transmission technique has been introduced into the subscriber communication path. As a subscriber optical access system for providing a packet communication of large capacity at a low cost by using this optical transmission technique, an ATM passive optical network (hereinafter, referred to as an ATM-PON system) is known.

FIG. 28 is a block diagram showing the structure of the conventional ATM-PON system (multiplexing transmission system) 200. The ATM-PON system 200 shown in FIG. 28 comprises a plurality of remote stations 201 to 203, a passive signal combining/branching circuit 120, and a base station 201. The remote stations 201 to 203 are connected to the passive signal combining/branching circuit 120 respectively through the optical fibers 141 to 143, in a point-to-point way. The passive signal combining/branching circuit 120 and the base station 201 are connected by an optical fiber 144. Client systems 101 to 103 are respectively connected to the remote stations 201 to 203, and a local switch 105 is connected to the base station 210.

The ATM cells transferred from the client systems 101 to 103 are temporarily stored in the remote stations 201 to 203. Thereafter, the remote stations 201 to 203 supply the ATM cells to the optical fibers 141 to 143. Upon receipt of the ATM cells through the optical fibers 141 to 143, the passive signal combining/branching circuit 120 multiplexes the received ATM cells through the optical fiber 144 and transfers them to the base station 210. The base station 210 transfers the ATM cells received through the optical fiber 144 to the local switch 105.

In the ATM-PON system 200 shown in FIG. 28, in case of transferring the ATM cells received from the client systems 101 to 103 to the base station 210, the respective remote stations 201 to 203 use an ATM-PON frame (transfer frame) 220 shown in FIG. 29. This ATM-PON frame 220 consists of a synchronous bit string 221 and an ATM cell 222. This synchronous bit string 221 can realize the multiplexing through the optical fiber 144.

Upon receipt of the ATM cells from the client systems 101 to 103, the remote stations 201 to 203 create the ATM-PON frames 220 and transfer them to the base station 210. Upon receipt of the ATM-PON frames 220, the base station 210 adjusts the bit or frame synchronization and the receiving level, by using the synchronous bit string 221, to receive the ATM cells 222 within the ATM-PON frames 220. The receiving level means the value of, for example, optical intensity and transfer bit rate.

The ATM-PON frame 220 is advised in “Broadband optical access systems based on Passive Optical Networks (PON)” (ITU-T, G. 983.1).

As mentioned above, in the conventional ATM-PON system (multiplexing transmission system) 200, the ATM-PON frames 220 with the synchronous bit string 221 added for every ATM cell are used to transfer the ATM cells 222. Thus, the base station 210 can adjust the receiving level of the signal string transferred from the remote stations 201 to 203 and extract the ATM cells 222.

In the conventional ATM-PON system (multiplexing transmission system) 200, when connecting a client system of the method other than the ATM transmission method to the remote station, the remote station converts the IP packets received from the client system into the ATM cells through the AAL (ATM Adaptation Layer) processing. Then, the ATM cells are transferred to the base station 210 through the ATM-PON frames 220.

The above-mentioned conventional ATM-PON system (multiplexing transmission system), however, has the following problems.

A first problem is described here. A predetermined hour is necessary in order to adjust the bit or frame synchronization and the receiving level by use of the synchronous bit string. Accordingly, when the transmission bit rate becomes higher because of enlargement of the transmission bandwidth of the optical fiber, the synchronous bit string becomes longer in order to assure the predetermined hour. The share of the overhead for synchronization for the ATM cells transferred to the base station from the remote station becomes higher, which results in deteriorating the transfer efficiency of the ATM cells.

A second problem is that in case of connecting a client system of the method other than the ATM transmission method to a remote station, it is necessary to do the AAL processing for converting the transmission format of the client data received from the client system into the ATM cell format and therefore the transmission speed is restricted. Further, since the overhead is increased because of the conversion into the ATM cells, the transfer efficiency of the client data is deteriorated. For example, it is difficult to convert the gigabit Ether signals into the ATM cells through the AAL processing without dropping the transmission speed. When converting a variable length signal string such as IP packets into the ATM cells, the overhead of 20 to 30% is added, thereby deteriorating the transfer efficiency.

### SUMMARY OF THE INVENTION

Taking the above situation into consideration, an object of the present invention is to provide a multiplexing transmission system and its data transfer method capable of improving the transfer efficiency of the client frames, when a plurality of remote stations are connected to one base station through a common transmission medium and the client frames (ATM cells and IP packets) sent from the respective remote stations are multiplexed through the common transmission medium by use of the synchronous bit string and transferred to the base station.

Further, second object of the present invention is to provide a remote station for realizing the multiplexing transmission system. Further, the present invention aims to provide a base station for realizing the multiplexing transmission system.

According to the first aspect of the invention, a multiplexing transmission system, with a plurality of remote stations connected to one base station through a common transmission medium, for multiplexing client frames sent from the remote stations through the transmission medium according to each synchronous bit string and transferring the same to the base station, in which

the remote station comprises means for creating a transfer frame with one synchronous bit string added to at least one or more client frames and sending this transfer frame to the base station.

In the preferred construction, the remote station inserts positional information indicating a start position and an end position of the client frame stored in the transfer frame, into the same transfer frame.

According to the second aspect of the invention, a multiplexing transmission system, with a plurality of remote stations connected to one base station through a common transmission medium, for multiplexing payload data sent from the remote stations through the transmission medium according to each synchronous bit string and transferring the same to the base station, in which

the remote station comprises means for defining a client frame received from a client system as the payload data and creating a transfer frame with one synchronous bit string added to the payload data and sending this transfer frame to the base station.

In the preferred construction, the remote station inserts positional information indicating a start position and an end position of the payload data into the transfer frame.

In another preferred construction, the remote station inserts frame identification information indicating information type of the payload data into the transfer frame.

In another preferred construction, the remote station creates an encapsulated frame for storing the client frame, forms the transfer frame, with the several encapsulated frames, as the payload data, and inserts positional information indicating a start position and an end position of the encapsulated frame, into the same encapsulated frame.

In another preferred construction, the remote station inserts positional information indicating a start position and an end position of the payload data into the transfer frame, creates an encapsulated frame for storing the client frame, forms the transfer frame with the several encapsulated frames as the payload data, and inserts positional information indicating a start position and an end position of the encapsulated frame, into the same encapsulated frame.

In another preferred construction, the remote station inserts frame identification information indicating information type of the payload data into the transfer frame, creates an encapsulated frame for storing the client frame, forms the transfer frame with the several encapsulated frames as the payload data, and inserts positional information indicating a start position and an end position of the encapsulated frame, into the same encapsulated frame.

According to another aspect of the invention, a data transfer method in a multiplexing transmission system, with a plurality of remote stations connected to one base station through a common transmission medium, for multiplexing client frames sent from the remote stations through the transmission medium according to each synchronous bit string and transferring the same to the base station, in which

the remote station comprising the steps of

a process of creating a transfer frame with one synchronous bit string added to at least one or more client frames, and

a process of sending this transfer frame to the base station.

According to another aspect of the invention, a data transfer method in a multiplexing transmission system, with a plurality of remote stations connected to one base station through a common transmission medium, for multiplexing payload data sent from the remote stations through the transmission medium according to each synchronous bit string and transferring the same to the base station, in which

the remote station comprising the steps of

a process of defining a client frame received from a client system as the payload data and creating a transfer frame with one synchronous bit string added to the payload data, and

a process of sending this transfer frame to the base station.

According to another aspect of the invention, a remote station for adding a synchronous bit string to a client frame and sending the same to a base station, in order to multiplex the client frame through a transmission medium, which is designed to

create a transfer frame with one synchronous bit string added to at least one or more client frames and send this transfer frame to the base station.

According to a further aspect of the invention, a base station for receiving a client frame multiplexed and transferred through a transmission medium, which is designed to

receive the transfer frame with one synchronous bit string added to at least one or more client frames, from the remote station and extract the client frame based on the synchronous bit string included in the transfer frame.

According to a further aspect of the invention, a remote station for adding a synchronous bit string to payload data and sending the same to a base station, in order to multiplex the payload data through a transmission medium, which is designed to

define a client frame received from a client system as the payload data, create a transfer frame with one synchronous bit string added to this payload data, and send this transfer frame to the base station.

According to a still further aspect of the invention, a base station for receiving payload data multiplexed and transferred through a transmission medium, which is designed to

define the client frame which is transferred from a client system through a remote station, as the payload data, receive the transfer frame with one synchronous bit string added to this payload data, and extract the payload data based on the synchronous bit string included in the transfer frame.

Other objects, features and advantages of the present invention will become clear from the detailed description given herebelow.

### DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing the structure of a multiplexing transmission system 100 according to the embodiments of the present invention;

FIG. 2 is a block diagram showing the structure of a remote station 111 (112, 113) according to a first embodiment of the present invention;

FIG. 3 is a block diagram showing the structure of a base station 130 according to the first embodiment of the present invention;

FIG. 4 is a first view showing the structure of a transfer frame created by the remote station 111 (112, 113) shown in FIG. 2;

FIG. 5 is a second view showing the structure of a transfer frame created by the remote station 111 (112, 113) shown in FIG. 2;

FIG. 6 is a third view showing the structure of a transfer frame created by the remote station 111 (112, 113) shown in FIG. 2;

FIG. 7 is a fourth view showing the structure of a transfer frame created by the remote station 111 (112, 113) shown in FIG. 2;

FIG. 8 is a block diagram showing the structure of the remote station 111 (112, 113) according to a second embodiment of the present invention;

FIG. 9 is a block diagram showing the structure of the base station 130 according to the second embodiment of the present invention;

FIG. 10 is a first view showing the structure of a transfer frame created by the remote station 111 (112, 113) shown in FIG. 8;

FIG. 11 is a second view showing the structure of a transfer frame created by the remote station 111 (112, 113) shown in FIG. 8;

FIG. 12 is a third view showing the structure of a transfer frame created by the remote station 111 (112, 113) shown in FIG. 8;

FIG. 13 is a fourth view showing the structure of a transfer frame created by the remote station 111 (112, 113) shown in FIG. 8;

FIG. 14 is a fifth view showing the structure of a transfer frame created by the remote station 111 (112, 113) shown in FIG. 8;

FIG. 15 is a sixth view showing the structure of a transfer frame created by the remote station 111 (112, 113) shown in FIG. 8;

FIG. 16 is a seventh view showing the structure of a transfer frame created by the remote station 111 (112, 113) shown in FIG. 8;

FIG. 17 is an eighth view showing the structure of a transfer frame created by the remote station 111 (112, 113) shown in FIG. 8;

FIG. 18 is a block diagram showing the structure of the remote station 111 (112, 113) according to a third embodiment of the present invention;

FIG. 19 is a block diagram showing the structure of the base station 130 according to the third embodiment of the present invention;

FIG. 20 is a view showing the structure of payload data 401 of a transfer frame created by the remote station 111 (112, 113) shown in FIG. 18;

FIG. 21 is a first view showing the structure of an encapsulated frame created by an encapsulating unit 31 shown in FIG. 18;

FIG. 22 is a second view showing the structure of an encapsulated frame created by the encapsulating unit 31 shown in FIG. 18;

FIG. 23 is a third view showing the structure of an encapsulated frame created by the encapsulating unit 31 shown in FIG. 18;

FIG. 24 is a fourth view showing the structure of an encapsulated frame created by the encapsulating unit 31 shown in FIG. 18;

FIG. 25 is a fifth view showing the structure of an encapsulated frame created by the encapsulating unit 31 shown in FIG. 18;

FIG. 26 is a sixth view showing the structure of an encapsulated frame created by the encapsulating unit 31 shown in FIG. 18;

FIG. 27 is a seventh view showing the structure of an encapsulated frame created by the encapsulating unit 31 shown in FIG. 18;

FIG. 28 is a block diagram showing the structure of the conventional multiplexing transmission system 200; and

FIG. 29 is a view showing the structure of the transfer frame created by the conventional remote station 201 (202, 203) shown in FIG. 28.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

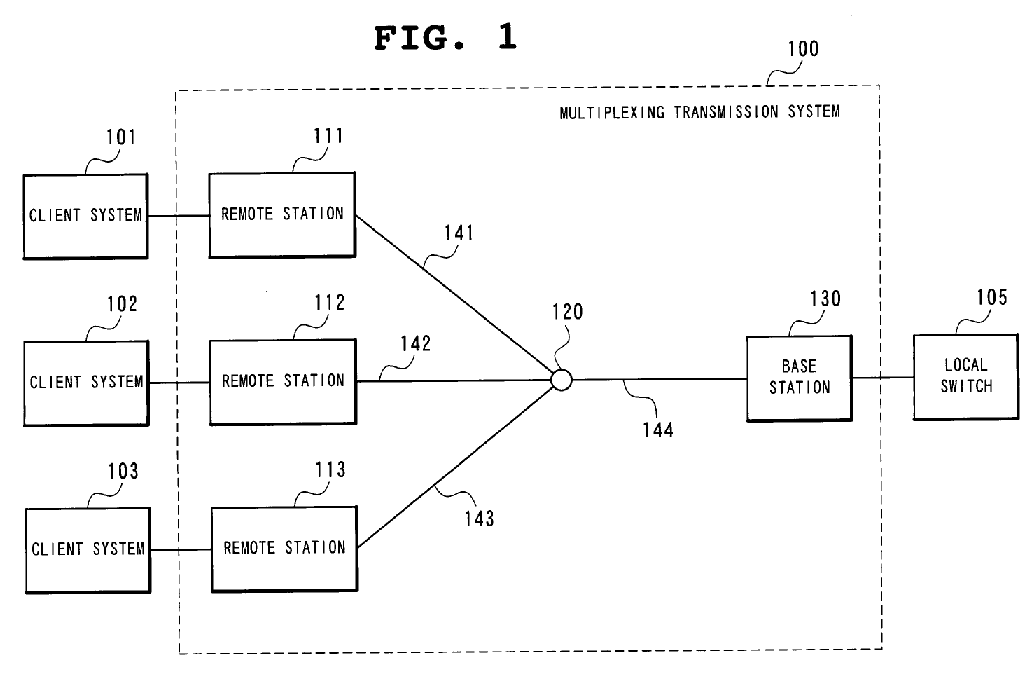

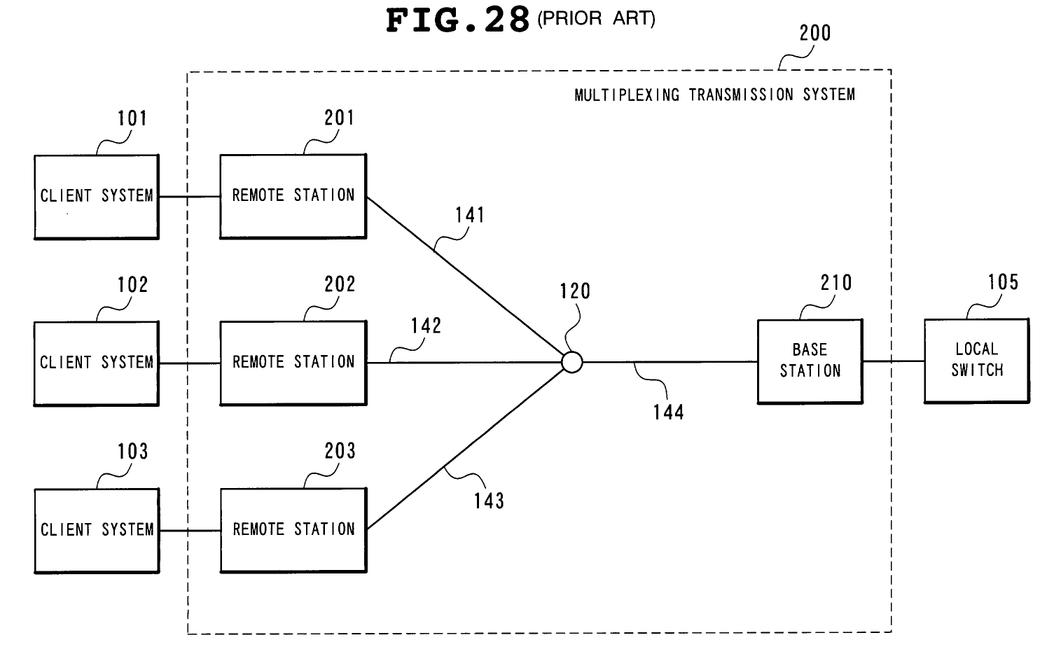

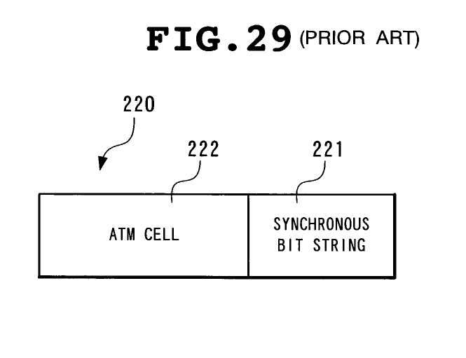

FIG. 1 is a block diagram showing the structure of a multiplexing transmission system according to the embodiments of the present invention. In FIG. 1, the same reference numerals are attached to the same portions as those of the conventional multiplexing transmission system shown in FIG. 28 and the description thereof is omitted.

In the multiplexing transmission system shown in FIG. 1, the remote stations 111 to 113 are connected to the passive signal combining/branching circuit 120 through the optical fibers 141 to 143 and the passive signal combining/branching circuit 120 and the base station 130 are connected by the optical fiber 144, similarly to the conventional multiplexing transmission system of FIG. 28. Client frames such as ATM (asynchronous transfer mode) cells and Internet Protocol (IP) packets sent from the respective remote stations 111 to 113 are multiplexed through the common optical fiber 144, according to the synchronous bit strings and transferred to the base station.

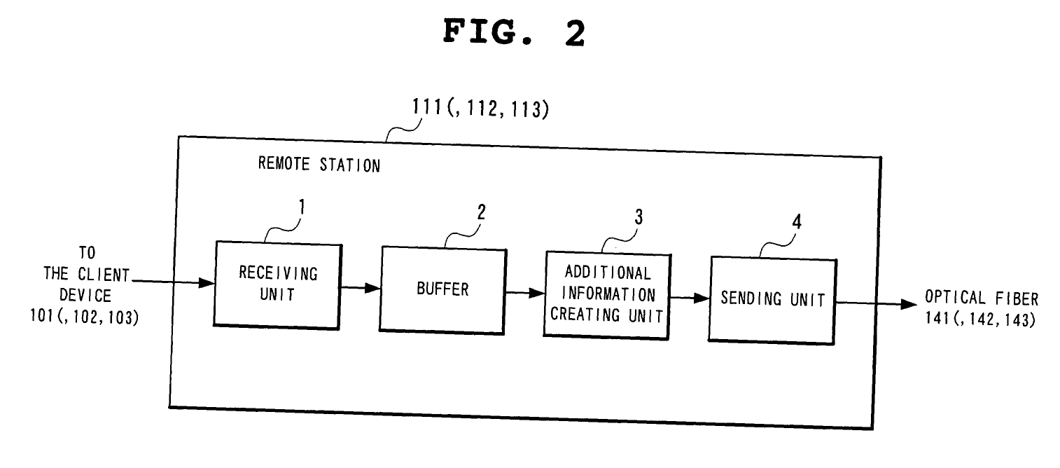

At first, a first embodiment will be described in case where the present invention is adopted to an ATM-PON system. FIG. 2 is a block diagram showing the structure of the remote station 111 (112, 113) according to the first embodiment. FIG. 3 is a block diagram showing the structure of the base station 130 according to the first embodiment.

In FIG. 2, the remote station 111 (112, 113) comprises a receiving unit 1 for receiving the ATM cells from the client system 101 (102, 103), a buffer 2 for temporarily storing the received ATM cells, an additional information creating unit 3 for creating additional information for the ATM cells stored in the buffer 2, and a sending unit 4 for creating a transfer frame with one synchronous bit string added to the above ATM cells and the additional information and sending the transfer frame to the optical fiber 141 (142, 143).

In FIG. 3, the base station 130 comprises a receiving unit 11 for receiving the transfer frame through the optical fiber 144 and extracting the ATM cells and the additional information according to the synchronous bit string of this transfer frame, an additional information analyzing unit 12 for analyzing the extracted additional information, a buffer 13 for storing the extracted ATM cells, an information processing unit 14 for performing the processing for taking out the ATM cells from the buffer 13 and transferring them to a local switch 105, and a sending unit 15 for receiving the ATM cells from the information processing unit 14 and sending them to the local switch 105.

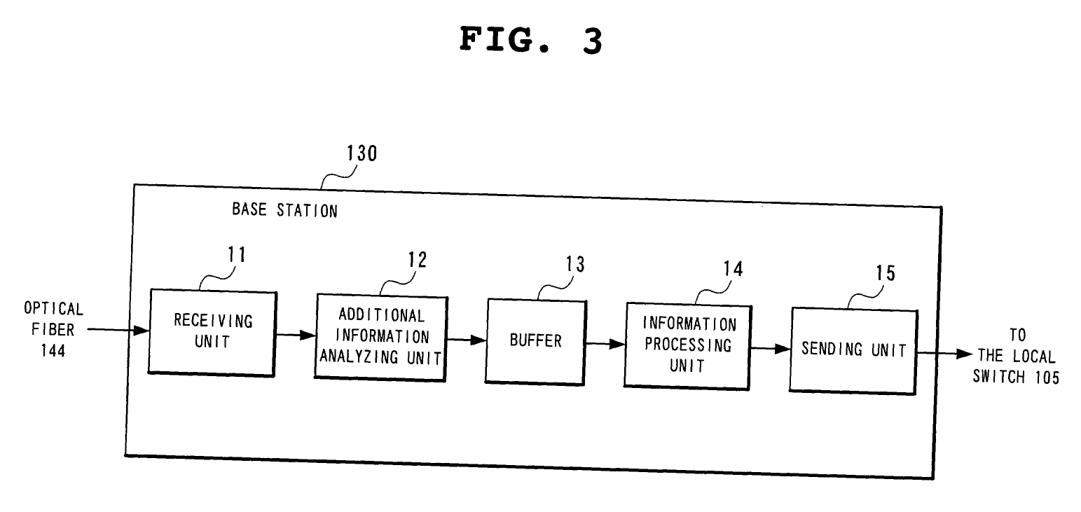

FIG. 4 to FIG. 7 are the first to the fourth views showing the structures of the respective transfer frames created by the remote station 111 (112, 113) shown in FIG. 2. The remote station 111 (112, 113) creates a transfer frame having one of the above structures shown in FIG. 4 to FIG. 7. With reference to FIG. 4 to FIG. 7, a data transfer method according to the first embodiment will be hereinafter described.

The transfer frame 300 shown in FIG. 4 consists of a synchronous bit string 301, payload data 302, and FCS (flag check sequence) 303. The synchronous bit string 301 is used for synchronizing the bit, byte, or frame of the transfer frame 300. The length of the payload data 302 is fixed and the payload data 302 includes one or several ATM cells transferred by the same remote station 111 (112, 113). The information for error detection or error detection/correction of the payload data 302 is stored in the FCS 303. Here, the FCS 303 may be omitted.

The remote station 111 (112, 113) creates the transfer frame 300 with the ATM cells stored in the buffer 2 defined as the payload data 302. The additional information creating unit 3 creates the FCS 303. Since the transfer frame 300 has a predetermined length (fixed length), the structure of the remote station for creating this transfer frame 300 can be realized at ease.

Upon receipt of the transfer frame 300, the base station 130 performs the bit synchronization or the byte/frame synchronization and adjusts the receiving level, by using the synchronous bit string 301, and extracts the ATM cells of the payload data 302.

The transfer frame 310 shown in FIG. 5 is designed to be capable of changing the length of the payload data 302. The transfer frame 310 consists of the synchronous bit string 301, flags (Flag) 304 and 305, payload data 302 of variable length, and FCS 303. The Flag 304 is positioned just before the payload data 302 of variable length, indicating the starting position of the payload data 302. While, the Flag 305 is positioned just after the FCS 303, indicating the end position of the transfer frame 310. These Flags 304 and 305 are created by the additional information creating unit 3. The Flags 304 and 305 include predetermined inherent information.

When the synchronous bit string 301 has a fixed length, the Flag 304 can be omitted. Further, the FCS 303 also can be omitted. In this case, the Flag 305 is to be positioned just after the payload data 302 of variable length.

Upon receipt of the transfer frame 310, the base station 130 can grasp the end position of the transfer frame 310 by recognizing the Flag 305. This processing is performed by the additional information analyzing unit 12.

When the same information patterns as those of the Flags 304 and 305 appear within the payload data 302 or the FCS 303, the additional information creating unit 3 and the additional information analyzing unit 12 respectively perform the bit/byte stuffing processing, which enables recognition of the Flags 304 and 305.

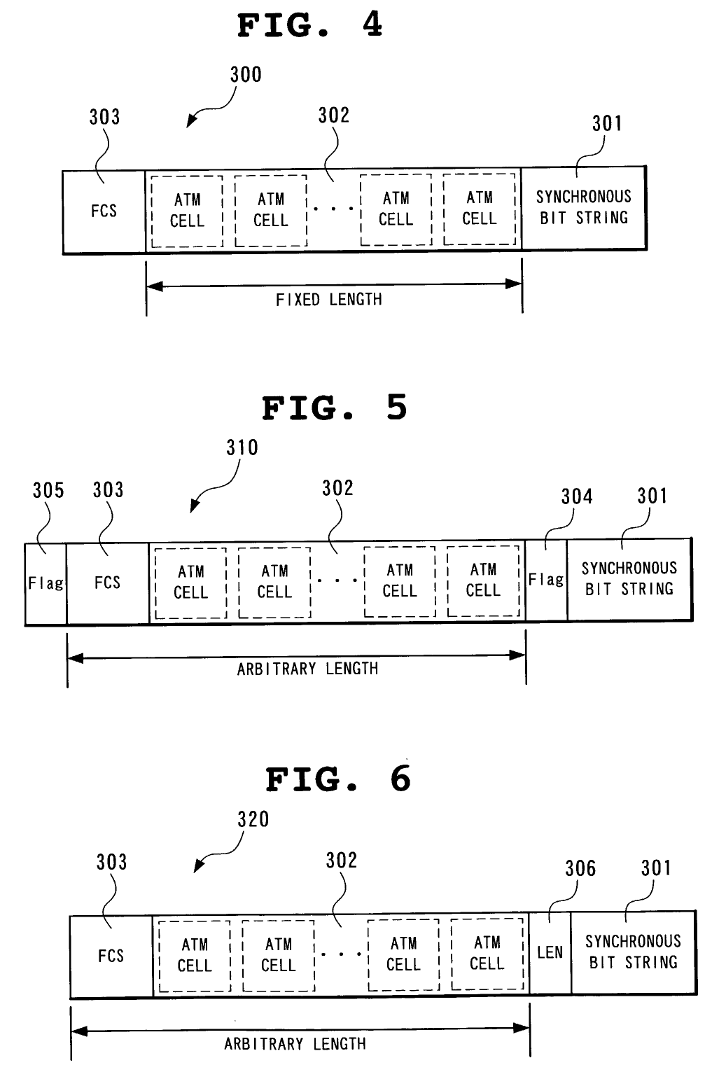

Though the transfer frame 320 shown in FIG. 6 has the structure capable of changing the length of the payload data 302, similarly to the above transfer frame 310, it has a frame length identifier (LEN) 306, instead of the Flags 304 and 305. The LEN 306 is created by the additional information creating unit 3.

The LEN 306 is the information based on the length of the transfer frame 320. For example, the LEN 306 may be the whole length of the transfer frame 320, or it may be the length of the remaining portion excluding the synchronous bit string 301. Or, it may be the length of only the payload data 302. As the unit of the length, bit length, byte length, ATM cell length, or fixed block length may be used.

Upon receipt of the transfer frame 320, the base station 130 can grasp the end position of the transfer frame 320 with reference to the LEN 306. This processing is performed by the additional information analyzing unit 12. If using the LEN 306 instead of the Flags 304 and 305, the above bit/byte stuffing processing is not necessary in the additional information creating unit 3 and the additional information analyzing unit 12.

Since the transfer frame 320 indicates the division of the frame or the number of the accommodated ATM cells by using the frame length identifier, it is not necessary to perform the bit/byte stuffing processing on the information within the frame, thereby realizing the structures of the remote station and the base station at ease.

The transfer frame 330 shown in FIG. 7 is designed so as to reply to a request to make the end position of the above transfer frame 320 more reliable. In this transfer frame 330, as shown in FIG. 7, a header error check (HEC) 307 for error detection or error detection/correction of the LEN 306 is positioned just after the LEN 306. The HEC 307 is created by the additional information creating unit 3. Further, in the base station 130, the additional information analyzing unit 12 performs the error detection or the error detection/correction of the LEN 306, based on the HEC 307.

The FCS 303 can be omitted also in the above transfer frames 320 and 330.

As mentioned above, in the first embodiment, the same remote station transfers the ATM cells (client frames) by using the transfer frames 300 to 330 capable of transferring a plurality of ATM cells at once. Thus, since an increase of the transfer overhead caused by the synchronous bit string can be restrained, it is effective in improving the transfer efficiency of the client frames.

Further, since the length of the payload data 302 is variable in the above transfer frames 310 to 330, the number of the ATM cells accommodated as the payload data 302 can be selected arbitrarily. Accordingly, since the frame length of the transfer frame can be varied depending on the number of the ATM cells to be transferred, it is effective in efficiently using the transmission bandwidth of the optical fiber 144 (common transmission medium).

This time, a second embodiment will be described in case where the present invention is adopted to a DATA-PON system. In the multiplexing transmission system shown in FIG. 1, the DATA-PON system is to multiplex not only the ATM cell but also the client frame such as IP packet through the optical fiber 144 according to the synchronous bit string and transfer the above to the base station 130.

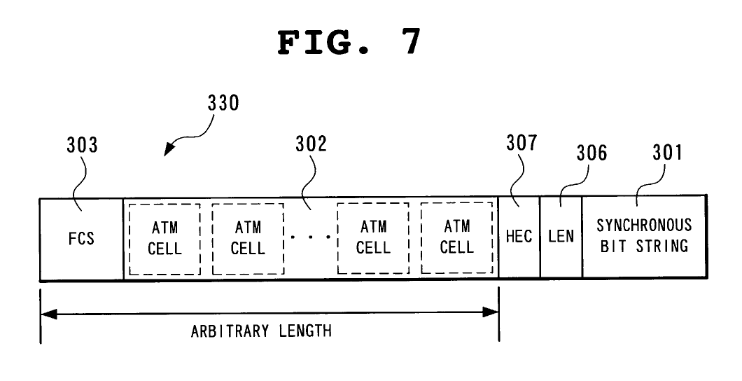

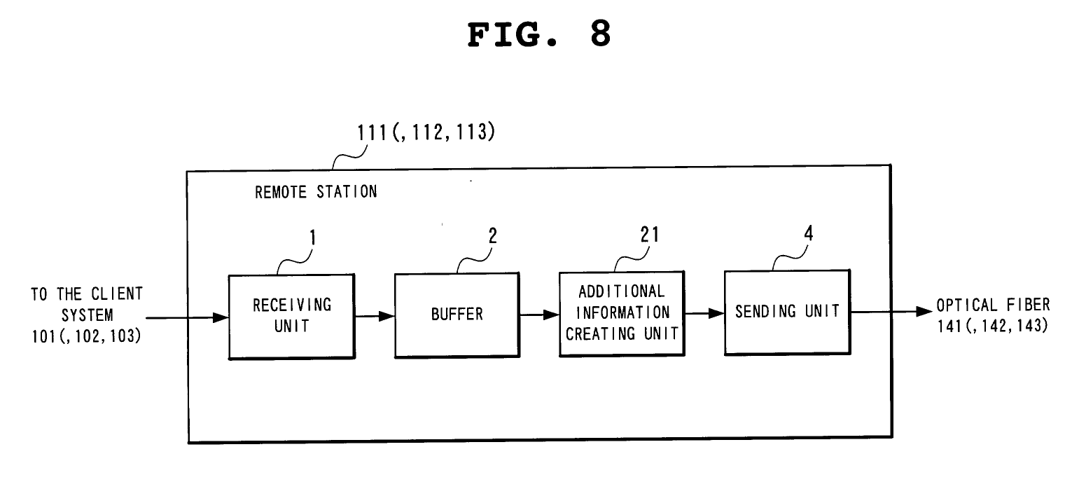

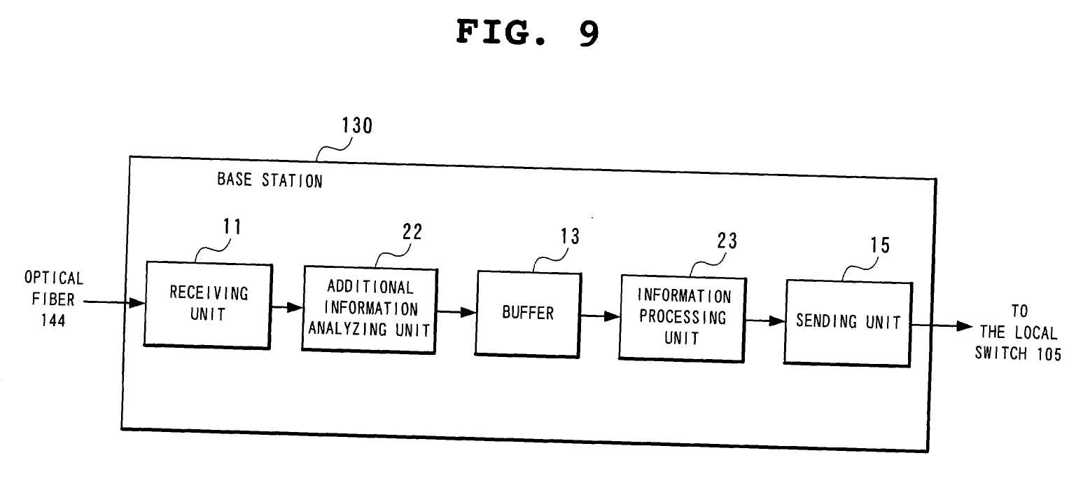

FIG. 8 is a block diagram showing the structure of the remote station 111 (112, 113) according to the second embodiment. FIG. 9 is a block diagram showing the structure of the base station 130 according to the second embodiment.

Though the remote station 111 (112, 113) shown in FIG. 8 has the same structure as that of FIG. 2, the receiving unit 1 receives various client frames (ATM cell, IP packet, and the like). Further, the additional information creating unit 21 creates the additional information based on the type of the client frame. Though the base station 130 shown in FIG. 9 has the same structure as that of FIG. 3, the additional information analyzing unit 22 analyzes the additional information within the received transfer frame. The information processing unit 23 performs the processing based on the type of the client frame.

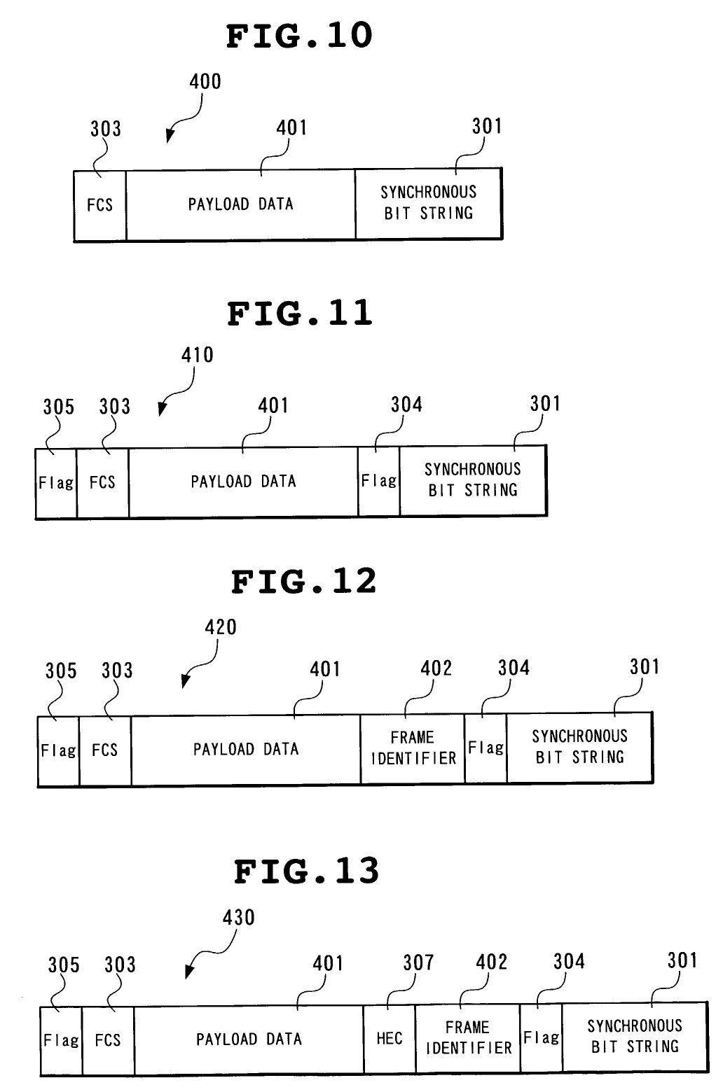

FIGS. 10 to 17 are the first to the eighth views showing the structures of the respective transfer frames created by the remote station 111 (112, 113) shown in FIG. 8. The remote station 111 (112, 113) creates a transfer frame having one of the above structures shown in FIG. 10 to FIG. 17. With reference to FIG. 10 to FIG. 17, a data transfer method according to the second embodiment will be hereinafter described. In FIGS. 10 to 17, parts corresponding to those in FIGS. 4 to 7 are given the same number and description therefor is omitted.

The transfer frame 400 shown in FIG. 10 consists of the synchronous bit string 301, payload data 401, and FCS (flag check sequence) 303. The payload data 401 has a fixed length, and the additional information creating unit 21 of the remote station 111 (112, 113) divides the client frame into the fixed length and defines it as the payload data 401. Alternatively, the payload data 401 is formed by a plurality of encapsulated frames described later. The additional information creating unit 21 creates the FCS 303 for error detection or error detection/correction of the payload data 401.

Upon receipt of the above transfer frame 400, the receiving unit 11 of the base station 130 performs the bit synchronization or the byte/frame synchronization and adjusts the receiving level by using the synchronous bit string 301 and extracts the payload data 401 and the additional information (FCS 303). The additional information analyzing unit 22 analyzes the extracted additional information (FCS 303).

In the above transfer frame 400, when the payload data 401 is formed by only the client frames of a specified frame structure and the data of the client frames accommodated in the payload data 401 indicates the length of the same frame, the payload data 401 can be variable.

The transfer frame 410 shown in FIG. 11 has the Flags 304 and 305, in order to make the length of the payload data 401 variable, similarly to the transfer frame 310 of FIG. 5. These Flags 304 and 305 are created by the additional information creating unit 21. The base station 130 recognizes the starting position of the payload data 401 by detecting the Flag 304 and recognizes the end of the transfer frame 410 by detecting the Flag 305.

Thus, the client frame length or the number of the client frames accommodated within the transfer frame can be selected arbitrarily. Accordingly, it is effective in efficiently using the transmission bandwidth of the optical fiber 144 (common transmission medium) by changing the length of the transfer frame depending on the length of the client frames or the number of the client frames to be transferred.

The transfer frame 420 shown in FIG. 12 has the frame identifier (frame identification information) 402 indicating the information type of the payload data 401. This frame identification 402 is formed by the attribute information of the payload data 401 and the attribute information of the transfer frame 420. The attribute information of the payload data 401 includes the connection information, the management information, and the protocol information about the client frame. The attribute information of the transfer frame 420 includes the presence or absence of the FCS 303. The additional information creating unit 21 creates the frame identifier 402.

Upon receipt of the transfer frame 420, the additional information analyzing unit 22 of the base station 130 grasps various attributes of the transfer frame 420 with reference to the frame identifier 402. Thus, even a client frame of different protocol can be multiplexed through the optical fiber 144 (common transmission medium) and transferred.

The transfer frame 430 shown in FIG. 13 has the HEC 307 for error detection or error detection/correction of the frame identifier 402, in order to enhance the reliability of the frame identifier 402. The additional information crating unit 21 creates the HEC 307. The additional information analyzing unit 22 performs the error detection or the error detection/correction of the frame identifier 402 based on the HEC 307.

The bit/byte stuffing processing is performed on the above transfer frames 410, 420, and 430, not to include the same information as that of the Flags 304 and 305 within the payload data 401 and the FCS 303. The Flag 304 can be omitted in any case.

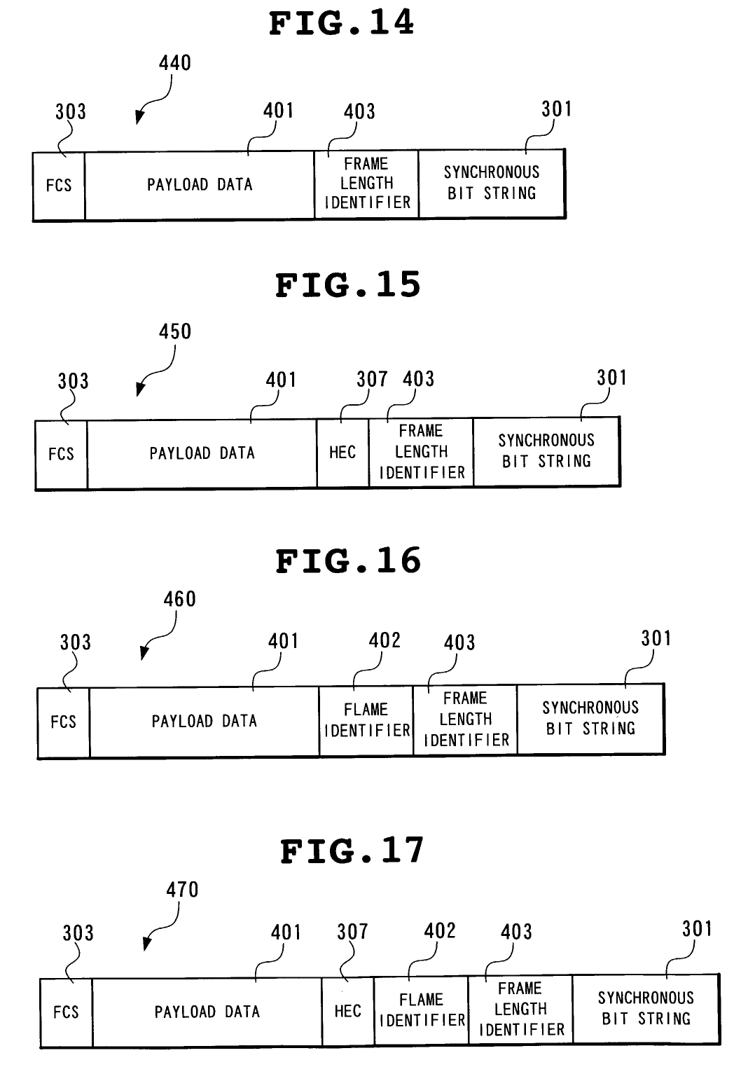

The transfer frame 440 shown in FIG. 14 has the frame length identifier 403, instead of the Flags 304 and 305, similarly to the transfer frame 320 of FIG. 6. In order to extract the payload data 401, the information capable of predicting the length of the transfer frame 440 is stored in the frame length identifier 403. As this information, the whole length of the transfer frame 440 can be used. Or, the length of the transfer frame 440 excluding one of the synchronous bit string 301 and the FCS 303 may be used. Or, the length of the transfer frame 440 excluding above both the synchronous bit string 301 and the FCS 303 may be used.

The additional information creating unit 21 creates the frame length identifier 403. The additional information analyzing unit 22 recognizes the end of the transfer frame 440 based on the frame length identifier 403. If using the frame length identifier 403, the above bit/byte stuffing processing is not necessary in the additional information creating unit 21 and the additional information analyzing unit 22.

The transfer frame 450 shown in FIG. 15 has the HEC 307 as for the frame length identifier 403, in order to enhance the reliability of the frame length identifier 403. The additional information creating unit 21 creates the HEC 307. The additional information analyzing unit 22 performs the error detection or the error detection/correction of the frame length identifier 403 based on the HEC 307.

The transfer frame 460 shown in FIG. 16 has the frame length identifier 403 and the frame identifier 402. The transfer frame 470 shown in FIG. 17 has the HEC 307 as for the frame length identifier 403 and the frame identifier 402 in order to enhance the reliability of the frame length identifier 403 and the frame identifier 402.

Although every transfer frame 400 to 470 mentioned above has the FCS 303, the FCS 303 may be omitted.

As mentioned above, according to the second embodiment, the remote station forms the transfer frame, as the payload data, from the client frames received from the client system without changing the format of the client frames. Accordingly, transmission speed is not restrained and overhead is not increased due to conversion into the ATM cells, differently from the conventional technique. As a result of this, it is effective in improving the transfer efficiency of the client frames.

A third embodiment will be described. As illustrated in FIG. 20, the third embodiment is designed to accommodate a plurality of encapsulated frames in the payload data 401 within the transfer frame of the second embodiment. When accommodating a plurality of client frames into the payload data 401, it is necessary to indicate the division of these client frames and therefore, the client frames are encapsulated.

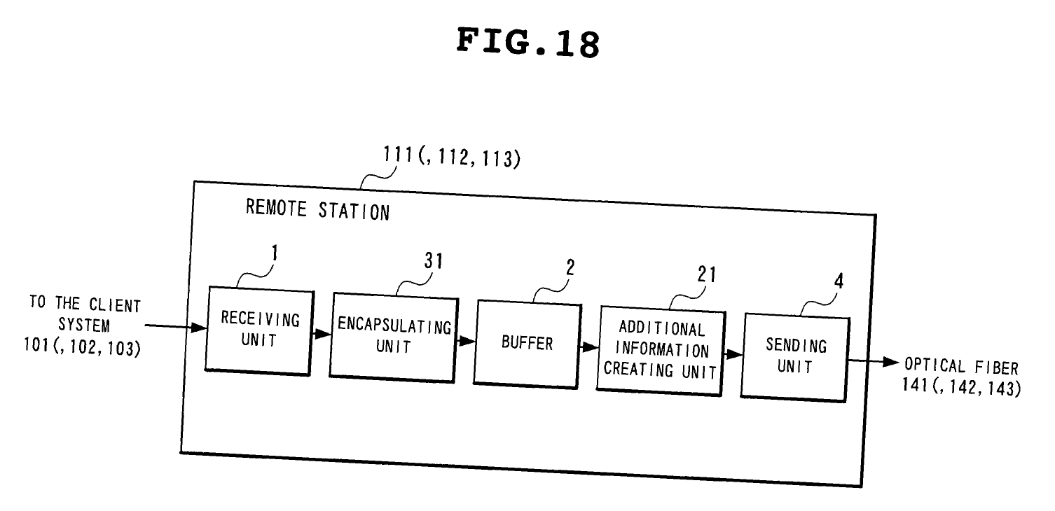

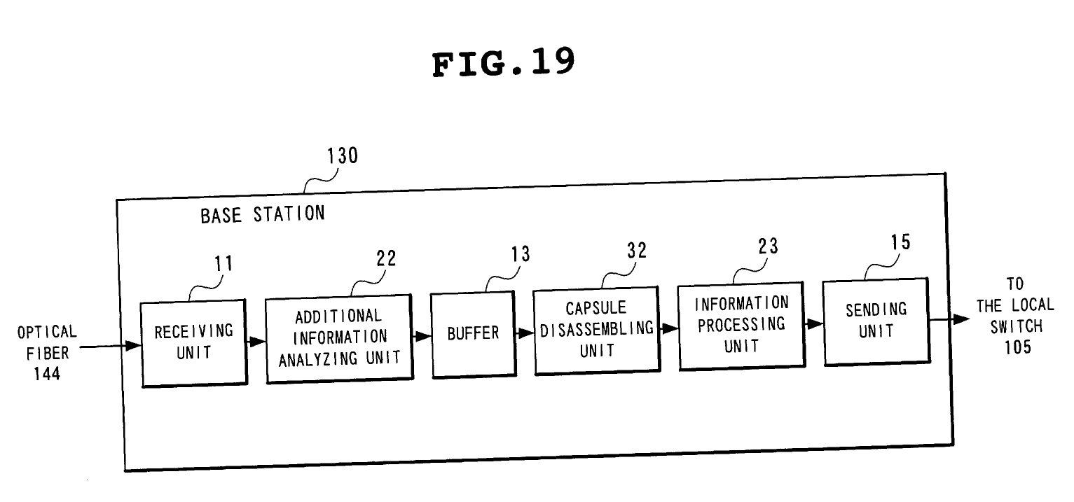

FIG. 18 is a block diagram showing the structure of the remote station 111 (112, 113) according to the third embodiment. FIG. 19 is a block diagram showing the structure of the base station 130 according to the third embodiment.

The remote station 111 (112, 113) shown in FIG. 18 is designed to have an encapsulating unit 31 for encapsulating each client frame to create each encapsulated frame, in addition to the structure of FIG. 8. The base station 130 shown in FIG. 19 is designed to have a capsule disassembling unit 32 for disassembling the encapsulated frame to take out the client frame, in addition to the structure of FIG. 9.

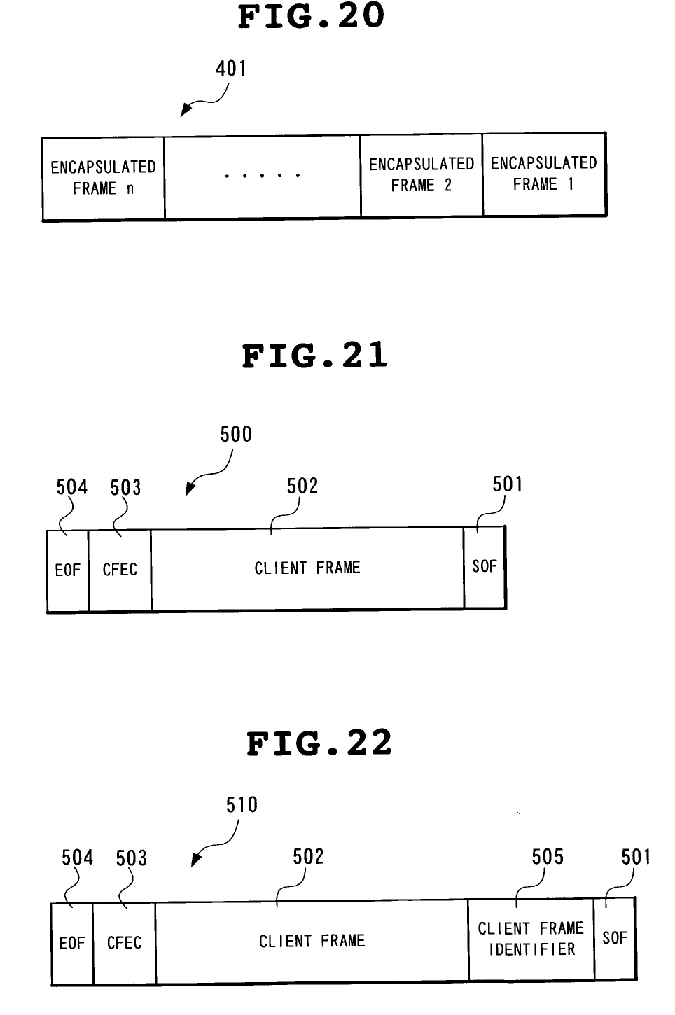

FIG. 21 to FIG. 27 are the first to the seventh views showing the structures of the respective encapsulated frames created by the encapsulating unit 31 of the remote station 111 (112, 113) shown in FIG. 18. The encapsulating unit 31 creates one of the encapsulated frames of FIGS. 21 to 27. A data transfer method according to the third embodiment will be hereinafter described with reference to FIGS. 21 to 27.

The encapsulated frame 500 shown in FIG. 21 consists of a start of frame (SOF) 501 indicating the start of the encapsulated frame 500, a client frame 502, a client frame error checker (CFEC) 503 for error detection or error detection/correction of the client frame 502, and an end of frame (EOF) 504 indicating the end of the encapsulated frame 500. The SOF 501 and the EOF 504 include the predetermined inherent information.

The encapsulating unit 31 creates the encapsulated frames 500. The capsule disassembling unit 32 recognizes the division of the encapsulated frames 500 accommodated in the payload data 401, according to the SOF 501 and the EOF 504 and extracts the client frame 502. The capsule disassembling unit 32 performs the error detection or the error detection/correction of the client frame 502 based on the CFEC 503.

The encapsulated frame 510 shown in FIG. 22 is designed to have a client frame identifier 505 in addition to the above encapsulated frame 500 of FIG. 21. The client frame identifier 505 includes the attribute information of the client frame 502 such as management information, quality, and connection. Or, it includes the attribute information of the encapsulated frame 510 itself.

When accommodating a plurality of client frames 502 of various types into the payload data 401, the type can be recognized by referring to the client frame identifier 505. The encapsulating unit 31 creates the client frame identifier 505. The capsule disassembling unit 32 or the information processing unit 23 grasps the type of the client frame 502 based on the client frame identifier 505.

The encapsulating unit 31 may insert the information for error detection or error detection/correction of the client frame identifier 505 as well as the client frame 502 in the CFEC 503. In this case, the capsule disassembling unit 32 performs the error detection or the error detection/correction of the client frame 502 and the client frame identifier 505, based on the CFEC 503.

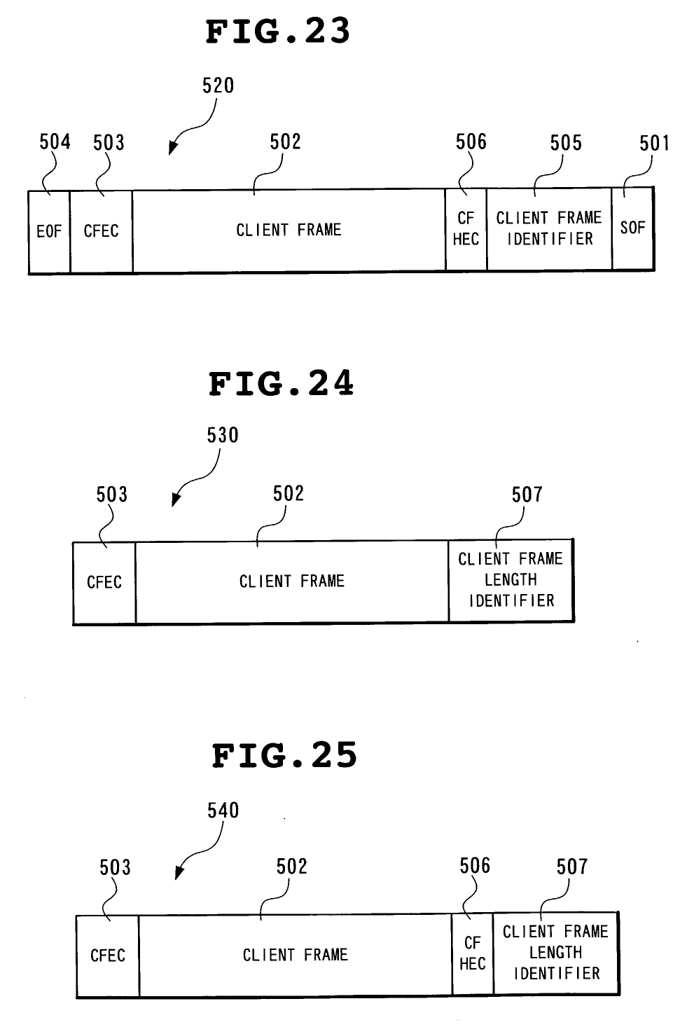

The encapsulated frame 520 shown in FIG. 23 is designed to have a client frame header error checker (CFHEC) 506 for error detection or error detection/correction of the client frame identifier 505, in order to enhance the reliability of the client frame identifier 505. The encapsulating unit 31 creates the CFHEC 506. The capsule disassembling unit 32 performs the error detection or the error detection/correction of the client frame identifier 505, based on the CFHEC 506.

In the encapsulated frames 500, 510, and 520, when the same information as that of the SOF 501 or the EOF 504 appears in the client frame 502, or the CFEC 503, or the CFHEC 506, the encapsulating unit 31 and the capsule disassembling unit 32 performs the respective bit/byte stuffing processing.

The encapsulated frame 530 shown in FIG. 24 is designed to have the client frame length identifier 507, the client frame 502, and the CFEC 503. The client frame length identifier 507 indicates the length of the client frame 502. Or, it may indicate the length of the sum of the client frame 502 and the CFEC 503, or it may indicate the whole length of the encapsulated frame 530.

The encapsulating unit 31 creates the client frame length identifier 507. The capsule disassembling unit 32 requires the end position of the encapsulated frame 530, based on the client frame length identifier 507.

The encapsulating unit 31 may insert the information of error detection or error detection/correction of the client frame length identifier 507 as well as the client frame 502 into the CFEC 503. In this case, the capsule disassembling unit 32 performs the error detection or the error detection/correction of the client frame 502 and the client frame length identifier 507, based on the CFEC 503.

The encapsulated frame 540 shown in FIG. 25 is designed to have the CFHEC 506 as for the client frame length identifier 507, in order to enhance the reliability of the client frame length identifier 507. The encapsulating unit 31 creates the CFHEC 506. The capsulate disassembling unit 32 performs the error detection or the error detection/correction of the client frame length identifier 507, based on the CFHEC 506.

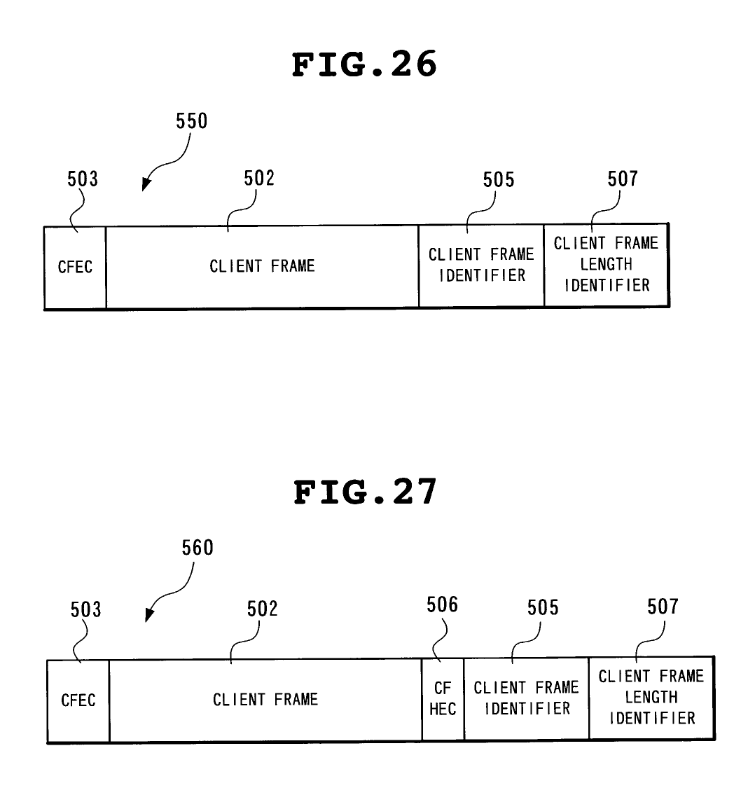

The encapsulated frame 550 shown in FIG. 26 is designed to have the client frame length identifier 507 and the client frame identifier 505. The encapsulated frame 560 shown in FIG. 27 is designed to have the CFHEC 506 as for the client frame length identifier 507 and the client frame identifier 505, in order to enhance the reliability of the client frame length identifier 507 and the client frame identifier 505.

In the encapsulated frames 550 and 560, disposition of the client frame length identifier 507 and the client frame identifier 505 may be inverted. The CFEC 503 of each encapsulated frame 500 to 560 may be omitted.

Like the third embodiment as mentioned above, if accommodating a plurality of encapsulated frames formed by encapsulating the client frames, into the payload data 401, it is possible to reduce the ill effects caused by an increase of the transfer overhead according to the synchronous bit string. Thus, it is effective in further improving the transfer efficiency of the client frames.

If the encapsulated frame is designed to include the client frame identifier, it is possible to accommodate the client frames of various kinds of protocols into the payload data 401 at once by encapsulation. As a result of this, it is possible to realize the efficient transfer of the client frames.

In the above-mentioned embodiments, although the present invention has been adopted to a passive optical network for multiplexing data through the optical fiber by using the synchronous bit string, it can be also adopted to another multiplexing transmission system.

As mentioned above, although the embodiments of the present invention have been described with reference to the drawings, the concrete structure is not restricted to these embodiments, but various modifications can be made without departing from the sprit of the present invention.

As set forth hereinabove, according to the present invention, since the ill effects caused by an increase of the transfer overhead according to the synchronous bit string are reduced, it is effective in improving the transfer efficiency of the client frames.

Further, if the positional information indicating the start position and the end position of the client frame is inserted into the transfer frame, it is possible to make the length of the transfer frame variable and therefore, to use the transmission bandwidth of the common transmission medium efficiently.

Further, according to the other embodiment of the invention, since the remote station is designed to form the transfer frames as the payload data, from the client frames received from the client system as they are, it is not necessary to change the transmission form of the client frame, differently from the conventional technique. Thus, it is possible to reduce such ill effects that, for example, the transmission speed is restricted because of the conversion of the client frames into the ATM cells and that the overhead is increased because of the same conversion. As a result of this, it is effective in improving the transfer efficiency of the client frames.

If the positional information indicating the start position and the end position of the payload data is inserted into the transfer frame, it is possible to make the length of the transfer frame variable and therefore, to use the transmission bandwidth of the common transmission medium efficiently.

If the frame identification information indicating the information type of the payload data is inserted into the transfer frame, it is possible to multiplex even the client frames of various kinds of protocols through the optical fiber 144 (common transmission medium) as the payload data.

If the encapsulated frames for storing the client frames are created, the transfer frame is formed by several encapsulated frames as the payload data, and the positional information indicating the start position and the end position of the encapsulated frame is inserted into the same encapsulated frame, it is possible to reduce the ill effects caused by an increase of the transfer overhead according to the synchronous bit string. Thus, it is effective in further improving the transfer efficiency of the client frames.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

In the claims:

1. A multiplexing transmission system, with a plurality of remote stations connected to one base station through a common transmission medium, for multiplexing client frames sent from said remote stations through said transmission medium according to each synchronous bit string and transferring the same to said base station, in which
said remote station comprising
means for creating a transfer frame with one synchronous bit string added to at least one or more client frames and sending this transfer frame to said base station.

2. The multiplexing transmission system as set forth in claim 1, in which
said remote station
inserts positional information indicating a start position and an end position of said client frame stored in said transfer frame, into the same transfer frame.

3. A multiplexing transmission system, with a plurality of remote stations connected to one base station through a common transmission medium, for multiplexing payload data sent from said remote stations through said transmission medium according to each synchronous bit string and transferring the same to said base station, in which
said remote station comprising
means for defining a client frame received from a client system as the payload data and creating a transfer frame with one synchronous bit string added to said payload data and sending this transfer frame to said base station.

4. The multiplexing transmission system as set forth in claim 3, in which
said remote station
inserts positional information indicating a start position and an end position of said payload data into said transfer frame.

5. The multiplexing transmission system as set forth in claim 3, in which
said remote station
inserts frame identification information indicating information type of said payload data into said transfer frame.

6. The multiplexing transmission system as set forth in claim 3, in which
said remote station
creates an encapsulated frame for storing said client frame, forms said transfer frame, with the several encapsulated frames, as said payload data, and
inserts positional information indicating a start position and an end position of the encapsulated frame, into the same encapsulated frame.

7. The multiplexing transmission system as set forth in claim 3, in which
said remote station
inserts positional information indicating a start position and an end position of said payload data into said transfer frame,
creates an encapsulated frame for storing said client frame, forms said transfer frame with the several encapsulated frames as said payload data, and
inserts positional information indicating a start position and an end position of the encapsulated frame, into the same encapsulated frame.

8. The multiplexing transmission system as set forth in claim 3, in which
said remote station
inserts frame identification information indicating information type of said payload data into said transfer frame,
creates an encapsulated frame for storing said client frame, forms said transfer frame with the several encapsulated frames as said payload data, and
inserts positional information indicating a start position and an end position of the encapsulated frame, into the same encapsulated frame.

9. A data transfer method in a multiplexing transmission system, with a plurality of remote stations connected to one base station through a common transmission medium, for multiplexing client frames sent from said remote stations through said transmission medium according to each synchronous bit string and transferring the same to said base station, in which
said remote station comprising the steps of:
a process of creating a transfer frame with one synchronous bit string added to at least one or more client frames, and
a process of sending this transfer frame to said base station.

10. A data transfer method in a multiplexing transmission system, with a plurality of remote stations connected to one base station through a common transmission medium, for multiplexing payload data sent from said remote stations through said transmission medium according to each synchronous bit string and transferring the same to said base station, in which
said remote station comprising the steps of:
a process of defining a client frame received from a client system as said payload data and creating a transfer frame with one synchronous bit string added to said payload data, and
a process of sending this transfer frame to said base station.

11. A remote station for adding a synchronous bit string to a client frame and sending the same to a base station, in order to multiplex the client frame through a transmission medium, which is designed to
create a transfer frame with one synchronous bit string added to at least one or more client frames and send this transfer frame to said base station.

12. A base station for receiving a client frame multiplexed and transferred through a transmission medium, which is designed to
receive the transfer frame with one synchronous bit string added to at least one or more client frames, from said remote station and extract said client frame based on the synchronous bit string included in said transfer frame.

13. A remote station for adding a synchronous bit string to payload data and sending the same to a base station, in order to multiplex the payload data through a transmission medium, which is designed to
define a client frame received from a client system as said payload data, create a transfer frame with one synchronous bit string added to this payload data, and send this transfer frame to said base station.

14. A base station for receiving payload data multiplexed and transferred through a transmission medium, which is designed to
define the client frame which is transferred from a client system through a remote station, as said payload data, receive said transfer frame with one synchronous bit string added to this payload data, and extract said payload data based on the synchronous bit string included in said transfer frame.
